(19) United States
(12) Patent Application Publication
(10) Pub. No.: US 2024/0119151 A1
(43) Pub. Date: Apr. 11, 2024

(54) INVISIBLE TROJAN SOURCE CODE DETECTION

(71) Applicant: International Business Machines Corporation, Armonk, NY (US)

(72) Inventors: Su Liu, Austin, TX (US); SARITHA ARUNKUMAR; Boyi Tzen; Luis Osvaldo Pizana, Austin, TX (US)

(21) Appl. No.: 17/938,174

(22) Filed: Oct. 5, 2022

(51) Int. Cl. G06F 21/56

(52) U.S. Cl. CPC G06F 21/563; G06F 21/564

(57) ABSTRACT

A computer implemented method, apparatus, system, and computer program product detects a problematic source code. A computer system loads a source code into a first memory. The computer system loads a rendered source code into a second memory. The rendered source code is a rendered version of the source code. The computer system determines a difference between the source code in the first memory and the rendered source code in the second memory. The computer system determines whether a problematic source code is present within the source code using the difference. The computer system performs a set of actions with respect to the problematic source code in response to determining that the problematic source code is present in the source code. According to other illustrative embodiments, a computer system and a computer program product for detecting a problematic source code are provided.

### BACKGROUND

### 1. Field

The disclosure relates generally to an improved computer system and more specifically to a method, apparatus, system, and computer program product for detecting invisible Trojan source code.

### 2. Description of the Related Art

Cybersecurity involves the protection of computer systems and networks from various malicious actions such as information disclosure, information theft, and damage to hardware, software, and data. Cybersecurity also includes protecting the systems from disruption or misdirection of services provided by the systems.

Many types of cybersecurity threats are present. For example, denial of service (DoS) attacks, direct access attacks, eavesdropping, phishing, privilege escalation, spoofing, and other kinds of cybersecurity issues are present. Trojan source vulnerability is a vulnerability that falls into a severe category. This category means that administrators and cybersecurity experts should give this type of vulnerability full attention.

The Trojan source vulnerability can affect any codebase regardless of the programming language. With the use of Unicode in displaying source code in browser interfaces using a bidirectional algorithm in the Unicode Specification through version 14.0. This algorithm performs a visual reordering of characters via control sequences and can be used to create source code that is rendered on a display showing a different logic than the logical ordering of tokens ingested by compilers and interpreters. In other words, the rendering of source code can result in a display of the source code that is different from the actual source code that can be compiled or interpreted and run. This vulnerability allows attackers to insert Trojan source code into almost any application creating a weakness for exploitation.

### SUMMARY

According to one illustrative embodiment, a computer implemented method detects a problematic source code. A computer system loads a source code into a first memory. The computer system loads a rendered version of the source code into a second memory. The rendered version of the source code forms a rendered source code in the second memory. The computer system determines a difference between the source code in the first memory and the rendered source code in the second memory. The computer system determines whether a problematic source code is present within the source code using the difference. The computer system performs a set of actions with respect to the problematic source code in response to determining that the problematic source code is present in the source code. According to other illustrative embodiments, a computer system and a computer program product for detecting a problematic source code are provided.

### BRIEF DESCRIPTION OF THE DRAWINGS

FIG. 1 is a block diagram of a computing environment in which illustrative embodiments can be implemented;

FIG. 2 is a block diagram of a source code environment in accordance with an illustrative embodiment;

FIG. 3 is a block diagram illustrating detection of problematic source code in accordance with an illustrative embodiment;

FIGS. 4A and 4B is a diagram of memory buffers used to detect problematic source code in accordance with an illustrative embodiment;

FIG. 5 is a flowchart of a process for analyzing source code in accordance with an illustrative embodiment;

FIG. 6 is a flowchart of a process for detecting problematic source code in accordance with an illustrative embodiment;

FIG. 7 is a flowchart of a process for analyzing problematic source code in accordance with an illustrative embodiment;

FIG. 8 is a flowchart of a process for analyzing problematic source code in accordance with an illustrative embodiment;

FIG. 9 is a flowchart of a process for updating a Trojan source pattern repository in accordance with an illustrative embodiment;

FIG. 10 is a flowchart of a process for analyzing problematic source code in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

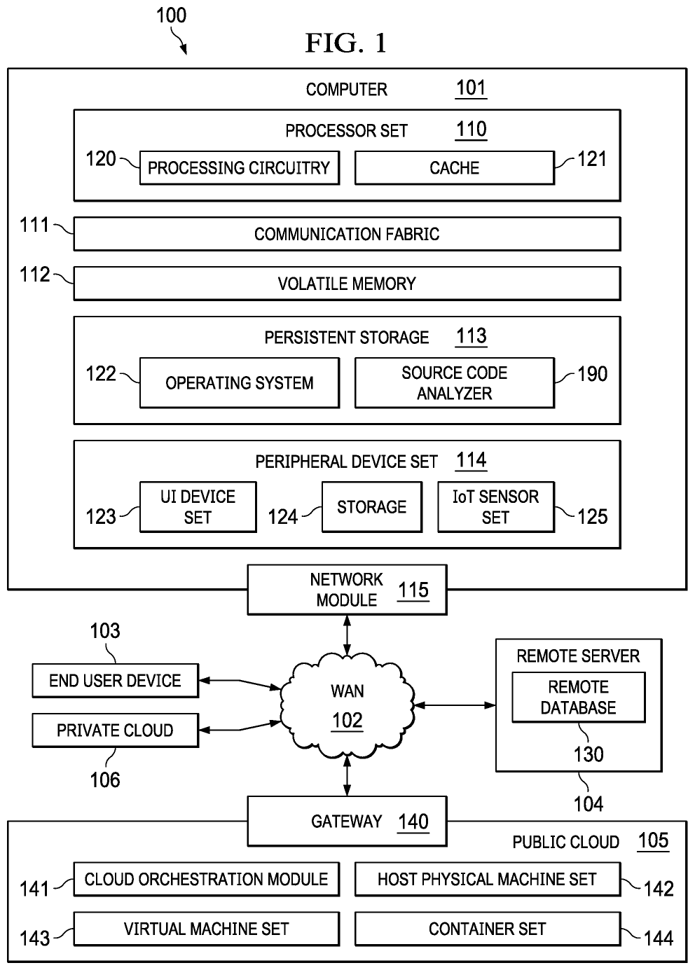

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as source code analyzer 190. In addition to source code analyzer 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and source code analyzer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in source code analyzer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in source code analyzer 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take content account a number of different considerations as described herein. For example, the illustrative embodiments recognize and take into account that the Trojan source vulnerability can be especially risky for browsers that display text using the bidirectional algorithm in Unicode. This vulnerability is a type of attack that cannot be perceived directly by a human user reviewing source code that has been rendered for display on a display device. This vulnerability can result in the introduction of harmful functions, the removal of safeguards, or both.

Identifying Trojan source code within the source code is difficult for a user visually reviewing the source code. In attempting to identify Trojan source code, a user can manually run a tool to search for control characters. The user needs to have knowledge about the layout of control characters in Unicode. Further, after finding these control characters, the user needs to find and review the related source code associated with the control characters and determine whether the related code is malicious source code. These steps require the user to have knowledge of the Unicode layout algorithm and have globalization skills. This type of process is time-consuming and error-prone and relies upon the skill and knowledge of the particular user reviewing the source code.

Thus, the illustrative embodiments provide a method, apparatus, system, and computer program product for detecting problematic source code within source code. In one illustrative example, a computer system loads a source code into a first memory. The computer system loads a rendered version of the source code into a second memory. The rendered version of the source code is a rendered source code in the second memory. The computer system determines a difference between the source code in the first memory and the rendered source code in the second memory. The computer system determines whether a problematic source code is present within the source code using the difference. The computer system performs a set of actions with respect to the problematic source code in response to determining that the problematic source code is present in the source code.

As used herein, a “set of” when used with reference to items means one or more items. For example, a set of actions is one or more actions.

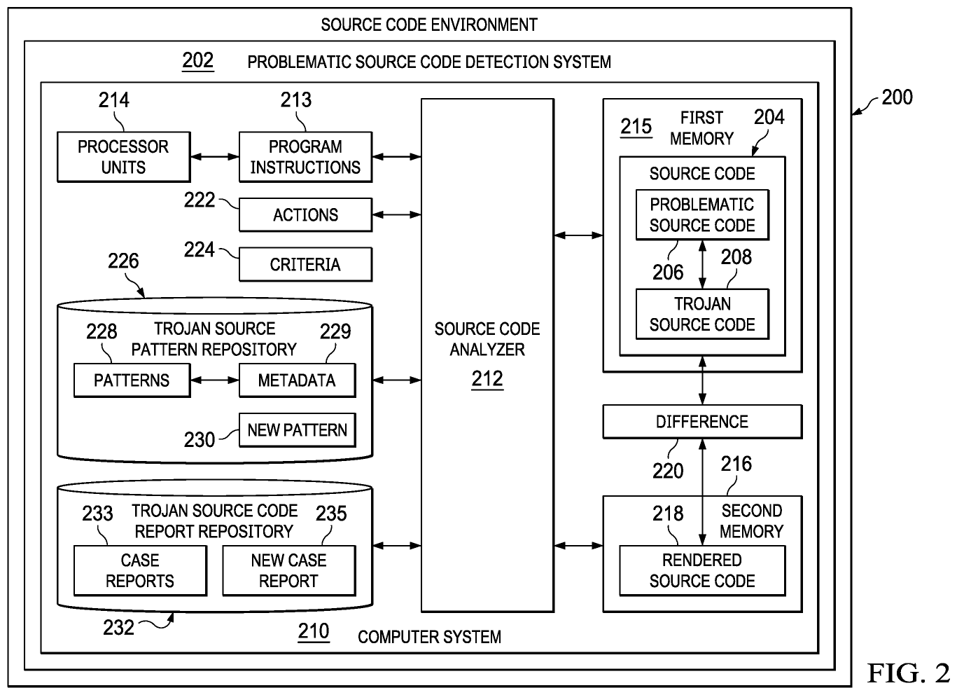

With reference now to FIG. 2, a block diagram of a source code environment is depicted in accordance with an illustrative embodiment. In this illustrative example, source code environment 200 includes components that can be implemented in hardware such as the hardware shown computing environment 100 in FIG. 1.

In this illustrative example, source code environment 200 includes components that can be implemented in hardware such as the hardware shown in computing environment 100 in FIG. 1. As depicted, problematic source code detection system 202 in source code environment 200 can detect and analyze source code 204 to determine whether problematic source code 206 is present in source code 204.

In this illustrative example, source code 204 is code written using a human readable programming language and is usually in plain text. Source code 204 can be, for example, C, C++, Java, Javascript or other languages that are human readable.

In this example, problematic source code 206 can be control symbols that modify the display of source code for a process. The process can be, for example, a function or a subroutine.

These control symbols control a display of text, but these control symbols are not displayed when source code 204 is rendered. In this example, problematic source code 206 can modify text or characters that are displayed using a bidirectional algorithm.

In one illustrative example, the control symbols comprise problematic source code 206. The control symbols can be control characters defined in Unicode. In another example, problematic source code 206 can be the control symbols and the related source code is modified by the control symbols. Problematic source code 206 can be Trojan source code 208. In other cases, problematic source code 206 can be for legitimate functions such as displaying characters in different languages in a desired manner.

For example, problematic source code 206 can include control characters that results in a function for compiling and executing code that is not rendered for display by to a user. As a result, the function can be included although the function is not intended for use in source code 204. This result occurs because the user does not see the source code for the function.

As another example, control characters can result in a display of text that looks like source code for a function in source code 204. However, this function is not actually present in source code 204 when source code 204 is compiled for execution. As a result, important functions such as verifying whether a user is authorized to access a resource can appear to be present but is omitted when source code 204 is compiled and executed.

In this illustrative example, problematic source code detection system 202 contains a number of different components. As depicted, problematic source code detection system 202 comprises computer system 210 and source code analyzer 212. Source code analyzer 212 is located in computer system 210. Source code analyzer 212 is an example of source code analyzer 190 in FIG. 1.

Source code analyzer 212 can be implemented in software, hardware, firmware or a combination thereof. When software is used, the operations performed by source code analyzer 212 can be implemented in program instructions configured to run on hardware, such as a processor unit. When firmware is used, the operations performed by source code analyzer 212 can be implemented in program instructions and data and stored in persistent memory to run on a processor unit. When hardware is employed, the hardware can include circuits that operate to perform the operations in source code analyzer 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 210 is a physical hardware system and includes one or more data processing systems. When more than one data processing system is present in computer system 210, those data processing systems are in communication with each other using a communications medium. The communications medium can be a network. The data processing systems can be selected from at least one of a computer, a server computer, a tablet computer, or some other suitable data processing system.

As depicted, computer system 210 includes a number of processor units 214 that are capable of executing program instructions 213 implementing processes in the illustrative examples. In other words, program instructions 213 are computer readable program instructions.

As used herein, a “number of” when used with reference to items, means one or more items. For example, a number of processor units 214 is one or more of processor units 214.

In this illustrative example, a processor unit in the number of processor units 214 is a hardware device and is comprised of hardware circuits such as those on an integrated circuit that respond and process instructions and program instructions that operate a computer. A processor unit can be implemented using processor set 110 in FIG. 1. When the number of processor units 214 execute program instructions 213 for a process, the number of processor units 214 can be one or more processor units that are on the same computer or on different computers. In other words, the process can be distributed between processor units on the same or different computers in a computer system. Further, the number of processor units 214 can be of the same type or different type of processor units. For example, the number of processor units 214 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, source code analyzer 212 can detect problematic source code 206 within source code 204 when problematic source code 206 is present. In this depicted example, source code analyzer 212 loads source code 204 into first memory 215. Further, source code analyzer 212 loads rendered version of source code 204 into second memory 216. These memories can be temporary memories in the form of memory buffers. The rendered version of source code 204 forms rendered source code 218 in second memory 216.

Source code analyzer 212 determines difference 220 between source code 204 in first memory 215 and rendered source code 218 in second memory 216. Source code analyzer 212 also determines if problematic source code 206 is present within source code 204 using difference 220. Source code analyzer 212 performs a set of actions 222 with respect to problematic source code 206 in response to determining that problematic source code 206 is present in source code 204.

In this illustrative example, the set of actions 222 can take a number of different forms. For example, the set of actions can be selected from at least one of: removing the problematic source code from the source code; sending an alert indicating a presence of problematic source code in the source code; graphically identifying the problematic source code in the source code; adding a pattern for the problematic source code to a Trojan source code report repository; sending the source code with an identification of the problematic source code to a reviewer; correcting the problematic source code in the source code in the first memory and saving the source code corrected for the problematic source code as a new version of the source code for review; determining a severity level for the problematic source code according to an impact scope; initiating an investigation to determine a root cause of the problematic source code; initiating the investigation to determine a contributor of the problematic source code; initiating a cleanup session to identify and correct the problematic source code in other source code in a source code database; reporting the problematic source code to a security entity; adding the contributor of the problematic source code to a watch list; suspending an account of the contributor of the problematic source code; broadcasting the report of the problematic source code to another integrated development environment; reporting the problematic source code as a new case to a Trojan source code report repository; or some other suitable action.

In this illustrative example, the set of actions 222 can be determined by source code analyzer 212 analyzing problematic source code 206 using a set of criteria 224. The set of criteria 224 can be one or more policies, rules, guidelines, requirements, or other type of standards that can be used to determine the set of actions 222. For example, the set of criteria 224 can be to remove problematic source code 206 and generate an alert as the set of actions 222 if source code 204 containing problematic source code 206 is used on a critical computer or is part of an essential program. The importance of the critical computer or essential program may be such waiting to determine whether problematic source code 206 is Trojan source code 208 or a legitimate source code is an undesired risk. For example, the critical computer can be a server computer for banking transactions. As another example, the essential program can be an access control application.

As another example, the set of criteria 224 can state that if problematic source code 206 in the difference is found in database problematic source code patterns that have been previously identified as Trojan source code, the set of actions 222 is to remove problematic source code 206 and generate an alert. In this example, Trojan source pattern repository 226 is a repository containing patterns 228 from problematic source code previously identified as Trojan source code. Patterns 228 can be generated when problematic source code has been identified as Trojan source code.

These example criteria for different actions are examples and not meant to limit the types of criteria 224 and types of actions 222 that can be taken. In other examples, if problematic source code 206 has not been previously identified as being Trojan source code, then problematic source code 206 can be sent to a reviewer such as a human analyst, a machine learning model, knowledge base, or other type of reviewer for analysis.

In analyzing problematic source code 206, source code analyzer 212 can search a Trojan source pattern repository 226 for a pattern matching problematic source code 206. In this example, Trojan source pattern repository 226 is a repository containing patterns 228 of different problematic source code identified as Trojan source code.

In this illustrative example, patterns 228 can also be associated with metadata 229. Metadata 229 can provide information used to determine the set of actions 222 using criteria 224. For example, metadata 229 can include information such as severity score, impact level, risk type, and other suitable formation. Metadata 229 can be a subset or summarized information. Source code analyzer 212 can determine the set of actions 222 based on a result of searching Trojan source pattern repository 226.

In this depicted example, a pattern in patterns 228 can uniquely identify Trojan source code. The pattern can contain a portion or all of the problematic source code. The pattern can be considered a fingerprint for the Trojan source code.

In this illustrative example, patterns 228 in Trojan source pattern repository 226 can be generated from a number of different sources. For example, patterns 228 can be generated based on case reports 233 in Trojan source code report repository 232. Case reports 233 can provide information on known Trojan source code that can be used to generate patterns 228.

Trojan source code report repository 232 is a source of information about Trojan source code. In one illustrative example, Trojan source code report repository 232 is a database for receiving Trojan source code reports. Trojan source code report repository 232 includes reports of known Trojan source code. A case report in this repository includes information such as a summary of the Trojan source code, a risk type, a risk name, a risk level, a severity score, an impact level, an attack complexity, privileges required, a patch, a pattern for a Trojan source code, or other information.

Source code analyzer 212 can monitor Trojan source code report repository 232 for new case reports. For example, in response to detecting new case report 235 in Trojan source code report repository 232, source code analyzer 212 generates new pattern 230. Source code analyzer 212 stores new pattern 230 in Trojan source pattern repository 226. As a result, patterns 228 can be generated when new Trojan source code is reported in Trojan source code report repository 232. Additionally, source code analyzer 212 can also generate metadata 229 for new pattern 230 from information in new case report 235.

In another illustrative example, source code analyzer 212 can analyze problematic source code 206 by searching Trojan source code report repository 232 for a case report describing problematic source code 206. This search can be performed in addition to or in place of the search of patterns 228 in Trojan source pattern repository 226.

In one illustrative example, one or more solutions are present that overcome a problem with source code being altered by invisible code such as control characters in Unicode that can control what code is displayed as compared to what code is compiled and executed. As a result, one or more solutions may provide an ability to increase protection of hardware systems, software, and data.

Computer system 210 can be configured to perform at least one of the steps, operations, or actions described in the different illustrative examples using software, hardware, firmware or a combination thereof. As a result, computer system 210 operates as a special purpose computer system in which source code analyzer 212 in computer system 210 enables increased protection against problematic source code, such as Trojan source code being introduced into a software that runs on computer system 210 or other computer systems. In particular, source code analyzer 212 transforms computer system 210 into a special purpose computer system as compared to currently available general computer systems that do not have source code analyzer 212.

In one illustrative example, the use of source code analyzer 212 in computer system 210 integrates processes into a practical application for detecting problematic source code that increases the performance of computer system 210. This increased performance is an increase in the ability to at least one of detecting the presence of problematic source code more accurately or in less time. In an illustrative example, source code analyzer 212 in computer system 210 is directed to a practical application of processes integrated into source code analyzer 212 in computer system 210 that compares source code in a first memory with a rendered version of the source code in a second memory. The difference between the source code and the rendered version of the source code can be used to identify problematic source code in the source code. The problematic source code can be analyzed to determine what actions to take in these examples. As a result, an improvement in the ability to detect problematic source code is presented using source code analyzer 212 as compared to current techniques.

The illustration of source code environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, source code analyzer can search one or more vulnerability repositories in addition to or in place of Trojan source code report repository 232 in FIG. 2 to determine whether problematic source code is a known Trojan source code that has been previously encountered and reported. As another example, source code analyzer 212 can receive other source code in addition to source code 204 at the same time for analysis. This additional source code can be analyzed using another pair of memories such as buffers. As yet another example, Trojan source code report repository 232 can be an external database containing Trojan source code reports instead of being located in computer system 210. With this implementation, Trojan source code report repository 232 can be maintained by a third party organization or organizations.

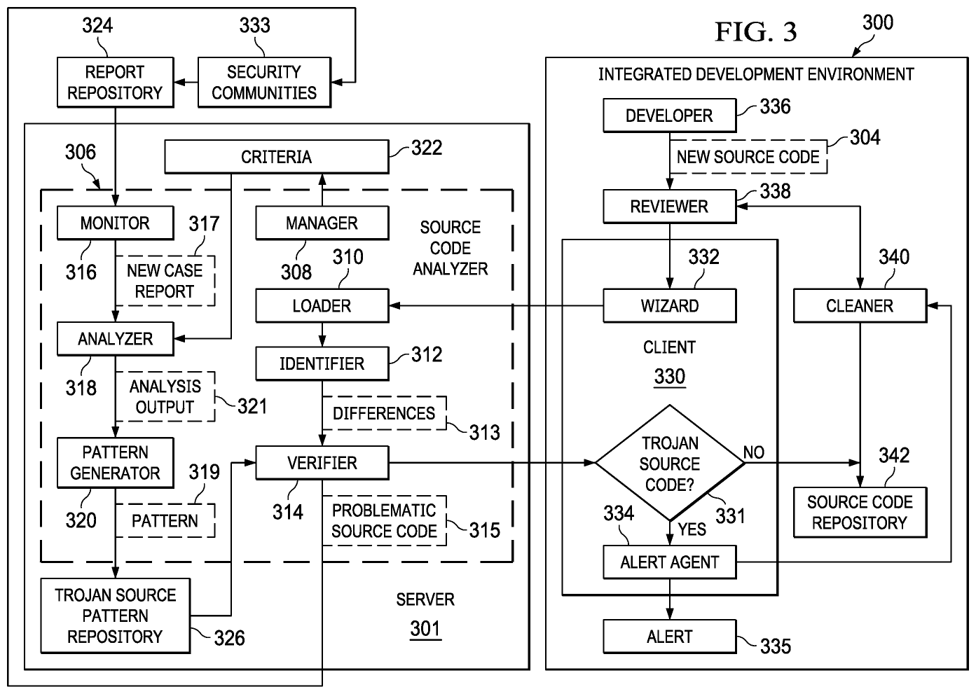

Turning now to FIG. 3, a block diagram illustrating detection of problematic source code is depicted in accordance with an illustrative embodiment. In this depicted example, integrated development environment 300 is an environment for developing source code such as new source code 304. Server 301 provides an ability to identify Trojan source code that may be hidden from view by reviewer 338 reviewing new source code 304. In this example, reviewer 338 is a human user.

Server 301 can be located in problematic source code detection system 202 in FIG. 2 and can analyze new source code 304 to determine whether problematic source code is present. Server 301 is software in this example and can run on hardware such as computer system 210 in FIG. 2.

In this example, source code analyzer 306 in server 301 is an example of an implementation of source code analyzer 212 in FIG. 2. As depicted in this example. source code analyzer 306 includes manager 308, loader 310, identifier 312, verifier 314, monitor 316, analyzer 318, and pattern generator 320.

Manager 308 is a user interface that maintains and configures source code analyzer 306. In this example, manager 308 configures and maintains criteria 322. In this example, criteria 322 is a set of rules for analyzing and identifying Trojan source code. Criteria 322 can be, for example, defined by code reviewers and security specialists.

As depicted, loader 310 can receive source code, such as new source code 304, and load the source code into a first memory such as memory buffer and a second memory such as a rendering buffer. In this example, loader 310 loads the source code into the memory buffer and loads a rendered version of the source code into the rendering buffer.

Identifier 312 identifies differences 313 between the source code in the memory buffer and the rendered source code in rendering buffer. The difference can be no difference. A difference may not always present between the source code in the memory buffer and rendered source code in the rendering buffer.

In this illustrative example, verifier 314 identifies the problematic source code in new source code 304 in response to a difference being present between new source code 304 in the memory buffer and the rendered version of new source code 304 in the rendering buffer.

For example, verifier 314 can identify control symbols in new source code 304. Further, verifier 314 can identify related source code that is associated with new source code 304 using the control symbols. The related source code is source code that is affected by the control symbols when rendering source code for display. The related source code and the control symbols can form the problematic source code in this example. In other examples, the control symbols are considered the problematic source code.

Additionally, verifier 314 determines whether the problematic source code is a Trojan source code using patterns in Trojan source pattern repository 326. If the problematic source code matches a pattern in Trojan source pattern repository 326, the problematic source code is considered Trojan source code. If the problematic source code does not match a pattern in Trojan source pattern repository 326, the problematic source may or may not be Trojan source code. In response to problematic source code 315 not being found in Trojan source pattern repository 326, verifier 314 sends problematic source code 315 as a new case report to security communities 333 for analysis.

In this depicted example, monitor 316 monitors report repository 324 for new case reports of Trojan source code. This repository is a database for receiving Trojan source code reports from different sources. This report repository can receive case reports with different formats. For example, a case report received at report repository 324 can comprise at least one of a screenshot image, plain text, piece of programming language code, a video file, or some other suitable format. The case reports can be normalized, parsed, and converted to formats for use in report repository 324.

In some cases, these case reports may include a pattern. For example, a pattern can be a pair of control symbols adhered with block symbols such as “RLO}LRI”, followed by “RLO{LRI”.

In other cases, patterns can be derived from information such as the Trojan source code or snippets of Trojan source code that may be included in the case reports. In some illustrative examples, report repository 324 can also include case reports identifying source code that are not considered to be Trojan source code.

In this illustrative examples, problematic source code may be reported and identified as not being Trojan source code. A new case report can be generated with this result. This type of report can be useful when the same problematic source code is reported many times from different users.

Analyzer 318 analyzes new reports of Trojan source code identified by monitor 316. In this illustrative example, analyzer 318 can be at least one of a knowledge base and machine learning model, or some other suitable analysis component.

The analysis of the new cases can be performed using criteria 322. This analysis can be used to determine whether problematic source code 315 identified in new source code 304 is not a normal or legitimate use of the problematic source code. For example, a legitimate use can be displaying Arabic script using control characters in Unicode. As part of the analysis, analyzer 318 can identify source code within a case report or using links to patterns in the case report to generate patterns.

In this illustrative example, pattern generator 320 generates Trojan source patterns from the Trojan source code identified by analyzer 318. Pattern generator 320 stores these patterns in Trojan source pattern repository 326.

As depicted in this illustrative example, integrated development environment 300 comprises a number of different components. As depicted, client 330 and cleaner 340 are components located in integrated development environment 300. These components can run on a computer system within integrated development environment 300.

Client 330 in this example is a client application. Client 330 can be, for example, a plug-in, extension, or some other suitable type of client application. Client 330 handles communications with source code analyzer 306 in server 301.

As depicted, client 330 comprises wizard 332 and alert agent 334. Wizard 332 is an application programming interface (API) that can check or scan new source code 304 developed by developer 336 in response to a user input from reviewer 338. Alert agent 334 can alert users such as reviewer 338 and developer 336 when suspected Trojan source code is identified by source code analyzer 306.

As depicted, cleaner 340 clean up new source code 304. For example, cleaner 340 can remove problematic source code 315 from new source code 304. Cleaner 340 can perform this removal by, for example, using the content of the rendering buffer to replace the contents in the memory buffer. The cleaned up source code from this process can be stored in source code repository 342. This cleaned up source code in source code repository 342 can be compiled to form a binary program for execution. In some cases, the cleaning can be performed automatically in response to receiving an indication that problematic or Trojan source code is present. In other illustrative examples, the initiation of cleaning may occur in response to a user input from reviewer 338.

In this example, source code repository 342 can be a database of source code that can store source code that has been developed. Further, users can obtain or extract source code from source code repository 342 use in applications.

With respect to data flow through these different components in server 301 and integrated development environment 300, developer 336 sends new source code 304 to reviewer 338. Reviewer 338 reviews new source code 304. In this illustrative example, reviewer 338 can initiate an analysis of new source code 304 by source code analyzer 306 in server 301 using client 330 in integrated development environment 300 as part of reviewing new source code 304. In some illustrative examples, the analysis of new source code 304 can occur automatically in response to reviewer 338 receiving new source code 304 for review.

In this example, wizard 332 uses an application programming interface (API) call to source code analyzer 306 to analyze new source code 304. In this illustrative example, wizard 332 sends new source code 304 to loader 310 as part of the API call.

In response to receiving the API call, loader 310 places new source code 304 into a memory buffer. Further, loader 310 renders new source code 304 into a form for display to form a rendered source code. This rendered source code is placed into a rendering buffer.

In this illustrative example, identifier 312 determines whether a difference is present between new source code 304 and the rendered source code. The difference can occur from use of control symbols in new source code 304. These control symbols can be, for example, control characters in Unicode processed using the Unicode Bidirectional Algorithm.

The control characters used with this algorithm can result in source code not being rendered for display to reviewer 338. As a result, source code in new source code 304 can be present for compiling the execution that is not seen by reviewer 338.

In another example, control characters can result in a display of text that looks like source code for a function or subroutine but is not compiled for execution. In this case, the control characters can make comments appear to be the source code for the function or subroutine. In this case, important code for functions or subroutines such as verifying a user can appear to be present to reviewer 338 but are omitted when new source code 304 is compiled and executed.

In this example, if a difference is not present, problematic source code is not present within new source code 304. In this case, verifier 314 sends an indication to client 330 that Trojan source code is not present in the new source code. In this case, client 330 determines that Trojan source code is not present in block 331 and sends new source code 304 to source code repository 342.

If a difference is present, verifier 314 identifies the problematic source code from the difference in the buffers. In this example, verifier 314 identifies control characters and can also identify related source code that is modified by control characters. Further, verifier 314 determines whether the problematic source code is present in Trojan source pattern repository 326. If problematic source code 315 matches a pattern, then an indication is sent to client 330 that Trojan source code is present in new source code 304.

In this example, if a match to a pattern is not found between problematic source code 315, a new case is considered to be present for analysis. In this case, problematic source code 315 can be sent to security communities 333 for analysis. Security communities 333 can comprise at least one of an organization, a company, a division in a company, a department in a company, an individual, a government agency or other entities that can analyze problematic source code 315 to determine whether problematic source code 315 is a threat. The analysis of problematic source code 315 can result in the generation of a case report for inclusion in report repository 324.

Further, when problematic source code 315 is found in new source code 304, verifier 314 sends an indication to client 330 that problematic source code 315 is Trojan source code or potential Trojan source code. In response to the determination that Trojan source code is present in block 331, cleaner 340 in client 330 removes problematic source code 315 from new source code 304. The cleaned source code is stored in source code repository 342.

If the problematic source code is identified as unknown, but not as Trojan source code, then client 330 can use cleaner 340 to remove problematic source code 315. This action can be taken when new source code 304 runs on an important computing device such as a gateway, is an access control feature, is a security feature, or provides some other function for which a more conservative approach is appropriate.

In other cases, if problematic source code 315 is identified as unknown but not as Trojan source code, new source code 304 can be stored in source code repository 342 without removing problematic source code 315 because problematic source code 315 has not been identified as Trojan source code. With this example, new source code 304 can be tagged or associated with metadata indicating that problematic source code 315 is present but whether problematic source code 315 is Trojan source code is unknown.

With this example of retaining problematic source code 315 in new source code 304, the process can be run again on new source code 304 after a period of time has passed. At a later time, new case report 317 may be present for problematic source code 315 that was sent to security communities 333 for analysis. In this case, a determination can now be made as to whether problematic source code 315 is actual Trojan source code.

In this illustrative example, alert agent 334 generates an alert 335 that is sent to at least one of reviewer 338, developer 336, a security expert, a security admin, or other user. Alert 335 can include information such as new source code 304 with highlighting or other graphical indicators of problematic source code 315 within new source code 304 that has been identified as potentially being Trojan source code. In this example, this alert can also include instructions to cleaner 340 as to whether problematic source code 315 should be removed from new source code 304.

Further in response to a determination that the problematic source code is Trojan source code, cleaner 340 can remove problematic source code 315 from new source code 304. In one illustrative example, cleaner 340 can replace new source code 304 in the memory buffer with the rendered source code in the rendering buffer. In this example, cleaner 340 then saves new source code 304 without problematic source code 315 in source code repository 342.

When monitor 316 detects new case report 317, monitor 316 sends new case report 317 to analyzer 318. Analyzer 318 summarizes and categorizes the trojan source code in new case report 317. Categories can be based on actions performed by the Trojan source code. Categories can be, for example, Trojan source code that deletes data, changes data, encrypts data, copies data, sends and receives files, slows computers, slows networks, and other actions.

Analyzer 318 sends analysis output 321 to pattern generator 320, analyzer 318 can locate the Trojan source code, pattern, or other information needed for generating pattern 319 when that information is not present in new case report 317.

In this this example, pattern generator 320 uses new case report 317 to generate pattern 319 for the Trojan source code identified in new case report 317. This pattern is saved in Trojan source pattern repository 326. In this example, metadata about problematic source code is also stored with the patterns in Trojan source pattern repository 326. The metadata can include, for example, at least one of a summary of the pattern, a risk type, a risk name, a category, a risk level, and other information that may be useful in determining how to handle the problematic source code. In the illustrative example, the pattern can be any information that can be used to uniquely identify a particular Trojan source code. The pattern can also be considered a fingerprint. A pattern can include at least one of a piece of code, an attribute, a location, or other information that can be used to identify the Trojan source code.

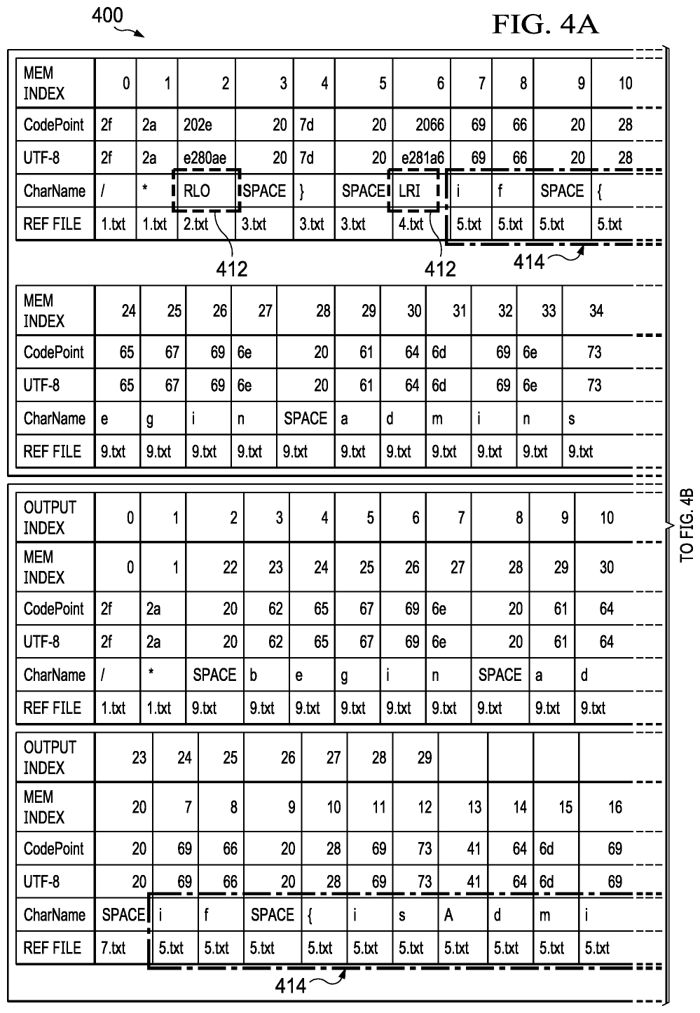

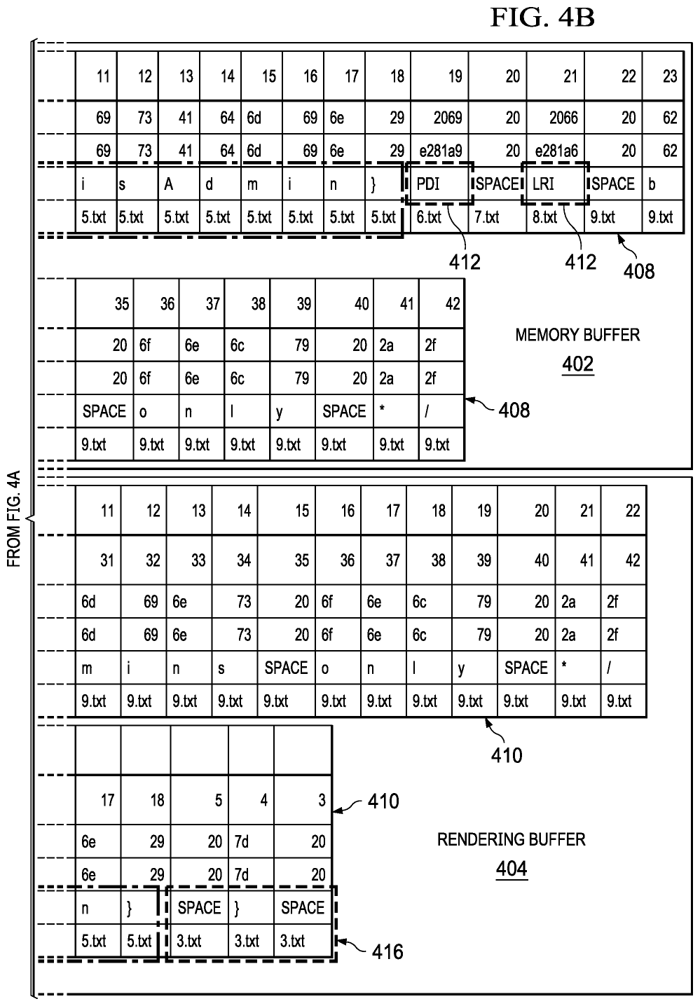

With reference to FIGS. 4A and 4B, a diagram of memory buffers used to detect problematic source code is depicted in accordance with an illustrative embodiment. In this illustrative example, buffers 400 comprise memory buffer 402 and rendering buffer 404. In this depicted example, memory buffer 402 is an example of an implementation for first memory 215 in FIG. 2, and rendering buffer 404 is an example of an implementation for second memory 216 in FIG. 2.

As depicted in this example, source code 408 is located in memory buffer 402 and rendered source code 410 is located in rendering buffer 404. Rendered source code 410 is a form of source code 408 rendered for display to a user.

In this example, control characters 412 are present in source code 408. These control characters are not located in rendered source code 410 in rendering buffer 404 because these control characters are not displayed.

As depicted, control characters 412 affect text 414 in rendered source code 410. More specifically, control characters 412 affect how text 414 is displayed. Text 414 can be for a process such as a function or subroutine.

In this example, text 414 in rendered source code 410 in rendering buffer 404 is displayed as code for steps in a process such as a function or subroutine that can be compiled and executed. In other words, text 414 appears to be source code that can be compiled and executed when rendered source code 410 is displayed. In this example, text 416 appears to be the comments that were located after text 414.

However, in source code 408, text 414 is actually part of comments rather than actual source code that can be compiled and executed. Control characters 412 change text 414 to appear to be source code for a function or subroutine represented by text 414 that can be in rendered source code 410. As a result, the user does not see that text 414 is actually part of a set of comments rather than actual source code for the function or subroutine.

In this illustrative example, rendered source code 410 is the source code that is reviewed and approved by the user. In response to a difference being present between source code 408 and rendered source code 410, rendered source code 410 can be used in place of source code 408 such that the function will actually be compiled and executed.

In this illustrative example, the illustration of source code in buffers is depicted as an example and not meant to limit the manner in which other illustrative examples can be implemented. For example, in another illustrative example text can be present in source code for a function that will be executed. The text for this function, however, shows up as comments when the source code containing the text is rendered to form rendered source code for display. As a result, processes such as functions or subroutines can be added that are not expected by user from reviewing the rendered source code.

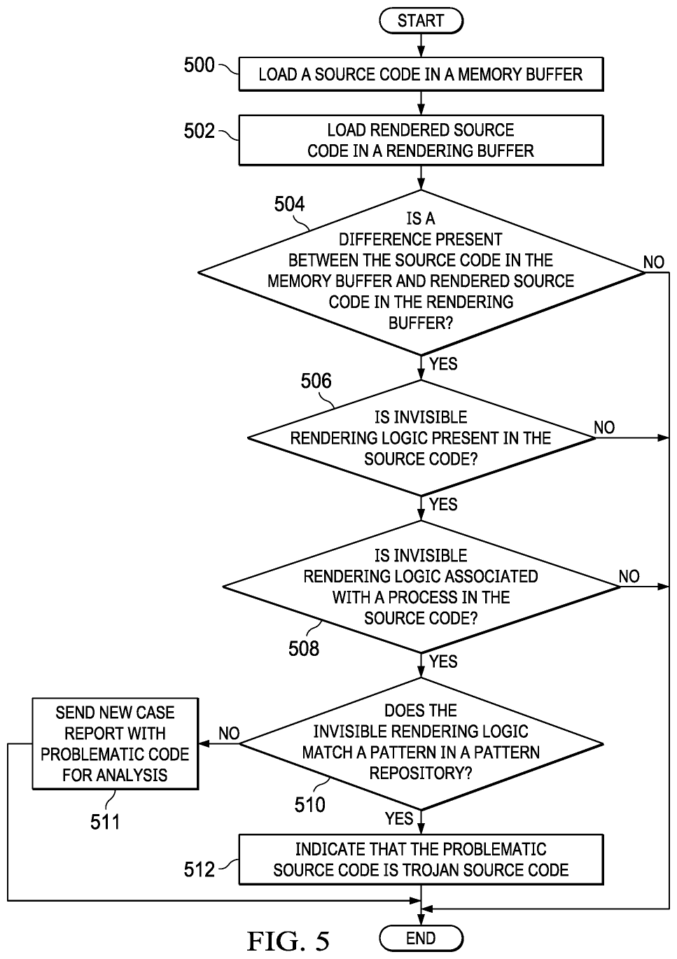

Turning next to FIG. 5, a flowchart of a process for analyzing source code is depicted in accordance with an illustrative embodiment. The process in FIG. 5 can be implemented in hardware, software, or both. When implemented in software, the process can take the form of program instructions that is run by one of more processor units located in one or more hardware devices in one or more computer systems. For example, the process can be implemented in source code analyzer 212 in computer system 210 in FIG. 2.

The process begins by loading source code in a memory buffer (step 500). The process also loads rendered source code in a rendering buffer (step 502). In step 500, the rendered source code is generated by a rendering engine that renders the source code.

A determination is made as to whether a difference is present between source code in the memory buffer and rendered source code in the rendering buffer (step 504). If a difference is not present between the source code and the rendered source code in these two memory buffers, the process terminates.

With reference again to step 504, if a difference is present, the process determines whether invisible rendering logic is present in the source code (step 506). In step 506, the invisible rendering logic can take the form of invisible control symbols. In one illustrative example, these invisible control symbols are control characters processed using a bidirectional algorithm in Unicode.

If invisible rendering logic is present, a determination is made as to whether the invisible rendering logic is associated with a process in the source code (step 508). In step 508, the invisible rendering logic can be associated with the process when the invisible rendering logic affects the display of the process in the source code. In this example, the process can be a function, a subroutine, or some other process that perform steps for a task. This process can be, for example, determining whether a user is an authorized user, checking a location of the requester, or some other process.

If a process is associated with the invisible rendering logic, a determination is made as to whether the invisible rendering logic matches a pattern in a pattern repository (step 510). In step 510, the pattern repository is a repository containing patterns for Trojan source code. The pattern repository can be, for example, Trojan source pattern repository 226 in FIG. 2 or Trojan source pattern repository 326 in FIG. 3. If the invisible rendering logic matches a pattern in the pattern repository, the process indicates that the problematic source code is Trojan source code (step 512) with the process terminating thereafter.

With reference again to step 510, if the invisible rendering logic does not match a pattern in the pattern repository, the process sends new case report with problematic code for analysis (step 511). The process terminates thereafter. In step 511, the report of the problematic code can be sent to an entity such as a security team, a security community, an administrator, or other entity for analysis. The security community can be in security communities 333 in FIG. 3.

With reference again to step 506, the process terminates if the invisible rendering logic is not present in the source code. The process also terminates in step 508 if the invisible rendering logic is not associated with the process in the source code. In these two cases, Trojan source code has not been identified.

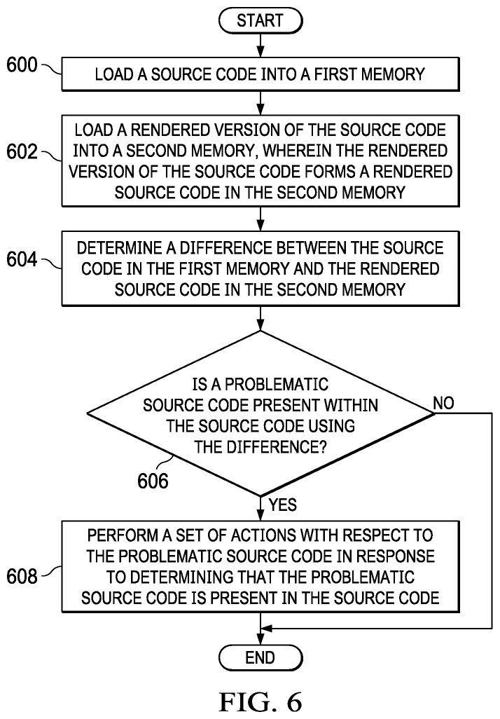

Turning next to FIG. 6, illustration a flowchart of a process for detecting problematic source code is depicted in accordance with an illustrative embodiment. The process in FIG. 6 can be implemented in hardware, software, or both. When implemented in software, the process can take the form of program instructions that is run by one of more processor units located in one or more hardware devices in one or more computer systems. For example, the process can be implemented in source code analyzer 212 in computer system 210 in FIG. 2.

The process begins by loading a source code into a first memory (step 600). The process loads a rendered source code into a second memory, wherein the rendered source code is a rendered version of the source code (step 602).

The process determines a difference between the source code and the rendered source code in the second memory (step 604). In step 604, the difference can be no difference in one illustrative example. In other words, the difference between the source code and the rendered source code can be none. The process determines whether a problematic source code is present within the source code using the difference (step 606). For example, the difference may indicate a presence of one or more characters or symbols that are present in the source code that are not found in the rendered source code. In this case, those characters or symbols are considered a difference between the source code and the rendered source code. The problematic source code is a process modified by control symbols controlling a display of text using a bidirectional algorithm.

The process performs a set of actions with respect to the problematic source code in response to determining that the problematic source code is present in the source code (step 608). The process terminates thereafter. With reference again to step 606, if the difference is not present between the source code in the first memory and the rendered source code in the second memory, the process terminates.

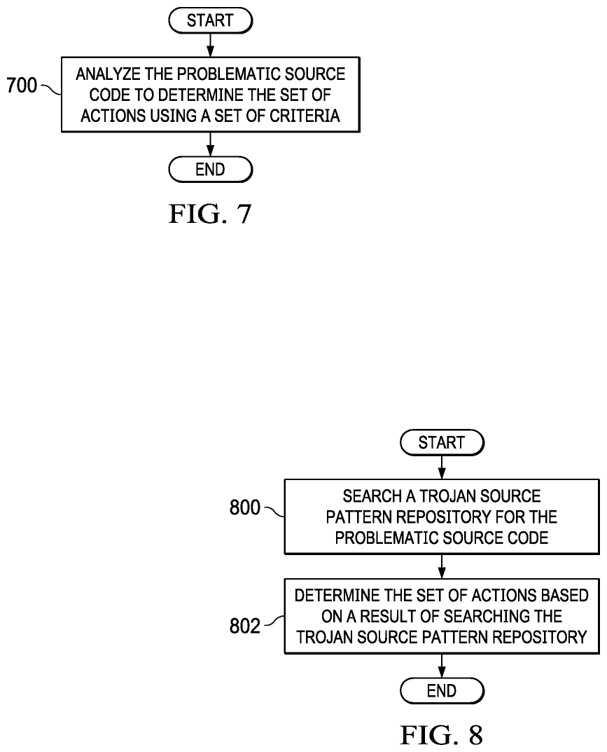

Turning next to FIG. 7, a flowchart of a process for analyzing problematic source code is depicted in accordance with an illustrative embodiment. The process illustrated in FIG. 7 is an example of an additional step that can be performed with the steps depicted in FIG. 6.

The process analyzes the problematic source code to determine the set of actions using a set of criteria (step 700) the process terminates thereafter. In step 700, the actions can be determined, based on the results and the set of criteria defining actions that can be performed. The analysis can determine, for example, whether the problematic source code is actual Trojan source code, unknown problematic source code, or a legitimate use of source code. Other information including a severity level, a complexity level, impact, or other information can be used to determine what actions may be taken with respect to problematic source code.

With reference to FIG. 8, a flowchart of a process for analyzing problematic source code is depicted in accordance with an illustrative embodiment. The process in FIG. 8 is an example of an implementation for step 700 in FIG. 7.

The process begins by searching a Trojan source pattern repository for the problematic source code (step 800). The process determines the set of actions based on a result of searching the Trojan source pattern repository (step 802) the process terminates thereafter.

In this example, the analysis searches for a pattern matching the problematic source code. If a match is present, the problematic source code is Trojan source code and an action is selected based on that determination. If a match is absent, the problematic source code is unknown and may or may not be Trojan source code. Actions can be selected based on the result of searching the Trojan source pattern repository.

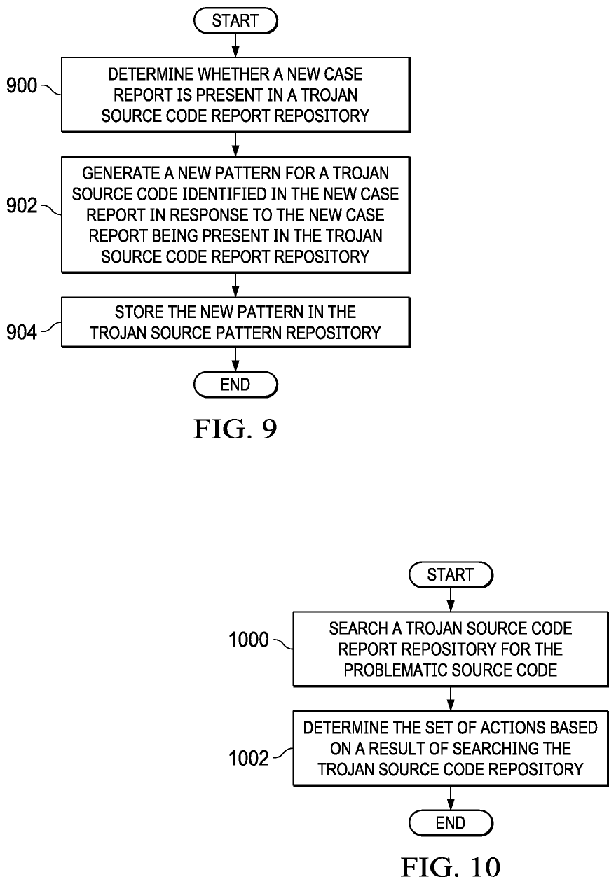

In FIG. 9, a flowchart of a process for updating a Trojan source pattern repository is depicted in accordance with an illustrative embodiment. The process in FIG. 9 can be implemented in hardware, software, or both. When implemented in software, the process can take the form of program instructions that is run by one of more processor units located in one or more hardware devices in one or more computer systems. For example, the process can be implemented in source code analyzer 212 in computer system 210 in FIG. 2. This process can be used in addition to the steps illustrated in FIG. 6 and provides to the Trojan source pattern repository searched using the steps in FIG. 8.

The process begins by determining whether a new case report is present in a Trojan source code report repository (step 900). The process generates a new pattern for a Trojan source code identified in the new case report in response to the new case report being present in the Trojan source code report repository (step 902).

The process stores the new pattern in the Trojan source pattern repository (step 904). The process terminates thereafter.

Turning to FIG. 10, a flowchart of a process for analyzing problematic source code is depicted in accordance with an illustrative embodiment. The process in FIG. 10 is an example of an implementation for step 700 in FIG. 7.

The process begins by searching a Trojan source code report repository for the problematic source code (step 1000). The process determines the set of actions based on a result of searching the Trojan source code repository (step 1002). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

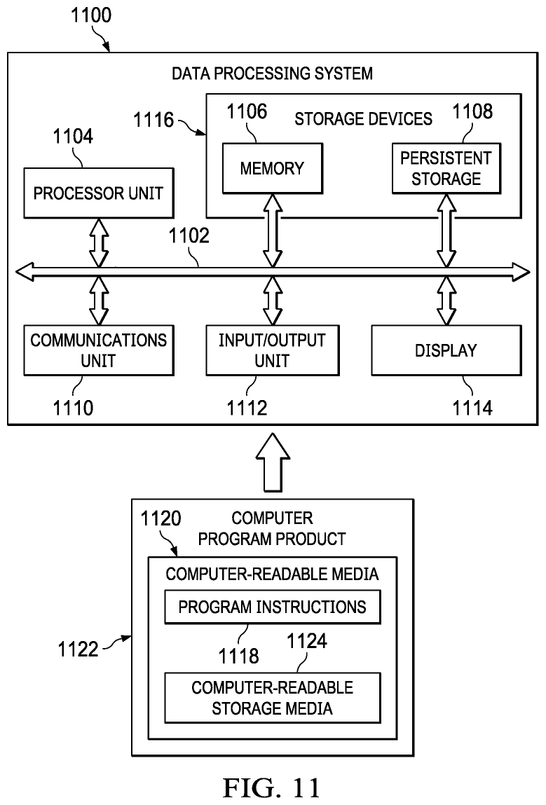

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 210 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can may be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 1118 is located in a functional form on computer-readable media 1120 that is selectively removable and can be loaded onto or transferred to data processing system 1100 for execution by processor unit 1104. Program instructions 1118 and computer-readable media 1120 form computer program product 1122 in these illustrative examples. In the illustrative example, computer-readable media 1120 is computer-readable storage media 1124.

Computer-readable storage media 1124 is a physical or tangible storage device used to store program instructions 1118 rather than a medium that propagates or transmits program instructions 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer-readable signal media. The computer-readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1120” can be singular or plural. For example, program instructions 1118 can be located in computer-readable media 1120 in the form of a single storage device or system. In another example, program instructions 1118 can be located in computer-readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer-readable media 1120 in a server computer while another portion of program instructions 1118 can be located in computer-readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present invention provide a computer implemented method, computer system, and computer program product for detecting a problematic source code. A computer system loads a source code into a first memory. The computer system loads a rendered version of the source code into a second memory, wherein the rendered version of the source code to form a rendered source code in the second memory. The computer system determines a difference between the source code in the first memory and the rendered source code in the second memory. The computer system determines whether a problematic source code is present within the source code using the difference. The computer system performs a set of actions with respect to the problematic source code in response to determining that the problematic source code is present in the source code.

In one or more illustrative examples, a source code analyzer can be implemented to perform Trojan source code identification. Further, in one or more of these examples, the source code analyzer can also remove Trojan source code identified in source code. In these illustrative examples, the source code analyzer can be implemented to analyze source code in response to a user request automatically when new source code is detected. The source code analyzer in one or more illustrative examples provides a mechanism for identifying and handling Trojan source code without requiring users to have knowledge and experience with invisible control symbols that can be present in source code. Further, the source code analyzer in one or more illustrative examples can alert various parties including reviewers, security administrators, and other users when problematic source code is identified. Additionally, the source code analyzer in one or more examples can also send problematic source code to various security personnel or organizations in security communities for analysis. In this manner, problematic source code can be analyzed and a determination can be made as to whether the problematic source code is Trojan source code.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for detecting a problematic source code, the computer implemented method comprising:
loading, by a computer system, a source code into a first memory;
loading, by the computer system, a rendered source code into a second memory, wherein the rendered source code is a rendered version of the source code;
determining, by the computer system, a difference between the source code and the rendered source code in the second memory;
determining, by the computer system, whether a problematic source code is present within the source code using the difference; and
performing, by the computer system, a set of actions with respect to the problematic source code in response to determining that the problematic source code is present in the source code.

2. The computer implemented method of claim 1 further comprising:
analyzing, by the computer system, the problematic source code to determine the set of actions using a set of criteria.

3. The computer implemented method of claim 2, wherein analyzing, by the computer system, the problematic source code to determine the set of actions using the set of criteria comprises:
searching, by the computer system, a Trojan source pattern repository for the problematic source code; and
determining, by the computer system, the set of actions based on a result of searching the Trojan source pattern repository.

4. The computer implemented method of claim 3 further comprising:
determining, by the computer system, whether a new case report is present in a Trojan source code report repository;
generating, by the computer system, a new pattern for a Trojan source code identified in the new case report in response to the new case report being present in the Trojan source code report repository; and
storing, by the computer system, the new pattern in the Trojan source pattern repository.

5. The computer implemented method of claim 2, wherein analyzing, by the computer system, the problematic source code to determine the set of actions using the set of criteria comprises:
searching, by the computer system, a Trojan source code report repository for the problematic source code; and
determining, by the computer system, the set of actions based on a result of searching the Trojan source code repository.

6. The computer implemented method of claim 1, wherein the problematic source code is a process modified by control symbols controlling a display of text using a bidirectional algorithm.

7. The computer implemented method of claim 1, wherein the set of actions is selected from at least one of removing the problematic source code from the source code; sending an alert indicating a presence of the problematic source code in the source code; graphically identifying the problematic source code in the source code; adding a pattern for the problematic source code to a Trojan source code report repository; sending the source code with an identification of the problematic source code to a reviewer; correcting the problematic source code in the source code in the first memory and saving the source code corrected for the problematic source code as a new version of the source code for reviewing; determining a severity level for the problematic source code according to an impact scope; initiating an investigation to determine a root cause of the problematic source code; initiating the investigation to determine a contributor of the problematic source code; initiating a cleanup session to identify and correct the problematic source code in other source code in a source code database; reporting the problematic source code to a security entity; adding the contributor of the problematic source code to a watch list; suspending an account of the contributor of the problematic source code; broadcasting the report of the problematic source code to another integrated development environment; or reporting the problematic source code as a new case to the Trojan source code report repository.

8. A computer system comprising:
a number of processor units, wherein the number of processor units executes program instructions to:
load a source code into a first memory;
load a rendered source code into a second memory, wherein the rendered source code is a rendered version of the source code;
determine a difference between the source code in the first memory and the rendered source code in the second memory;
determine whether a problematic source code is present within the source code using the difference; and
perform a set of actions with respect to the problematic source code in response to determining that the problematic source code is present in the source code.

9. The computer system of claim 8, wherein the number of processor units executes program instructions to:
analyze the problematic source code to determine the set of actions using a set of criteria.

10. The computer system of claim 9, wherein in analyzing the problematic source code to determine the set of actions using the set of criteria, the number of processor units executes program instructions to:
search a Trojan source pattern repository for the problematic source code; and
determine the set of actions based on a result of searching the Trojan source pattern repository.

11. The computer system of claim 10, wherein the number of processor units executes program instructions to:
determine whether a new case report is present in a Trojan source code report repository;
generate a new pattern for a Trojan source code identified in the new case report in response to the new case report being present in the Trojan source code report repository; and
store the new pattern in the Trojan source pattern repository.

12. The computer system of claim 10, wherein in analyzing the problematic source code to determine the set of actions using the set of criteria, the number of processor units executes program instructions to:
search a Trojan source code report repository for the problematic source code; and
determine the set of actions based on a result of searching the Trojan source code repository.

13. The computer system of claim 8, wherein the problematic source code is a process modified by control symbols controlling a display of text using a bidirectional algorithm.

14. The computer system of claim 8, wherein the set of actions is selected from at least one of removing the problematic source code from the source code; sending an alert indicating a presence of the problematic source code in the source code; graphically identifying the problematic source code in the source code; adding a pattern for the problematic source code to a Trojan source code report repository; sending the source code with an identification of the problematic source code to a reviewer; correcting the problematic source code in the source code in the first memory and saving the source code corrected for the problematic source code as a new version of the source code for reviewing; determining a severity level for the problematic source code according to an impact scope; initiating an investigation to determine a root cause of the problematic source code; initiating the investigation to determine a contributor of the problematic source code; initiating a cleanup session to identify and correct the problematic source code in other source code in a source code database; reporting the problematic source code to a security entity; adding the contributor of the problematic source code to a watch list; suspending an account of the contributor of the problematic source code; broadcasting the report of the problematic source code to another integrated development environment; or reporting the problematic source code as a new case to the Trojan source code report repository.

15. A computer program product for detecting a problematic source code, the computer program product comprising a computer readable storage medium having program instructions embodied therewith, the program instructions executable by a computer system to cause the computer system to perform a method of:
loading, by the computer system, a source code into a first memory;
loading, by the computer system, a rendered source code into a second memory, wherein the rendered source code is a rendered version of the source code;
determining, by the computer system, a difference between the source code in the first memory and the rendered source code in the second memory;
determining, by the computer system, whether a problematic source code is present within the source code using the difference; and
performing, by the computer system, a set of actions with respect to the problematic source code in response to determining that the problematic source code is present in the source code.

16. The computer program product of claim 15, wherein the method performed by the computer system further comprises:
analyzing, by the computer system, the problematic source code to determine the set of actions using a set of criteria.

17. The computer program product of claim 16, wherein analyzing, by the computer system, the problematic source code to determine the set of actions using the set of criteria comprises:
searching, by the computer system, a Trojan source pattern repository for the problematic source code; and
determining, by the computer system, the set of actions based on a result of searching the Trojan source pattern repository.

18. The computer program product of claim 17 further comprising:
determining, by the computer system, whether a new case report is present in a Trojan source code report repository;
generating, by the computer system, a new pattern for a Trojan source code identified in the new case report in response to the new case report being present in the Trojan source code report repository; and
storing, by the computer system, the new pattern in the Trojan source pattern repository.

19. The computer program product of claim 17, wherein analyzing, by the computer system, the problematic source code to determine the set of actions using the set of criteria comprises:
searching, by the computer system, a Trojan source code report repository for the problematic source code; and
determining, by the computer system, the set of actions based on a result of searching the Trojan source code repository.

20. The computer program product of claim 15, wherein the problematic source code is a process modified by control symbols controlling a display of text using a bidirectional algorithm.
